(19) United States
(12) Patent Application Publication
(10) Pub. No.: US 2024/0308823 A1
(43) Pub. Date: Sep. 19, 2024

(54) SLING MECHANISM FOR LIFTING CONTAINER

(71) Applicant: Hebei Qinhuai Data Co., Limited., Zhangjiakou City (CN)

(72) Inventors: Binghua ZHANG, Zhangjiakou City (CN); Mingjiang LI, Zhangjiakou City (CN)

(21) Appl. No.: 18/595,504

(22) Filed: Mar. 5, 2024

(30) Foreign Application Priority Data
Mar. 16, 2023 (CN) 202310252253.7

(51) Int. Cl. B66F 7/28; B66F 7/02

(52) U.S. Cl. CPC B66F 7/28; B66F 7/02

(57) ABSTRACT

The present disclosure discloses a sling mechanism for lifting a container, including a frame body. A supporting wheel is arranged on the frame body, and the supporting wheel comes into contact with a steel rope. A balance mechanism is arranged inside the frame body, a lifting frame is fixedly connected to the steel rope, and a sliding block is slidably connected to the lifting frame. A lifting drum is welded onto the sliding block, a lifting mechanism is arranged inside the lifting drum, and a regulating mechanism is arranged inside the lifting frame. The balance mechanism includes a motor fixedly installed on the frame body, where a rotation shaft of the motor is rotatably connected to the frame body. A gear is welded onto the rotation shaft, and the gear is meshed with a gear rack.

### CROSS REFERENCE TO RELATED APPLICATION

This application claims priority to Chinese Patent Application No. 202310252253.7, titled “SLING MECHANISM FOR LIFTING CONTAINER” and filed to the China National Intellectual Property Administration on Mar. 15, 2023, the entire contents of which are incorporated herein by reference.

### TECHNICAL FIELD

The present disclosure relates to the field of sling, and more particularly, to a sling mechanism for lifting a container.

### BACKGROUND

When containers are moved, cranes and slings are needed. The invention patent with patent application publication number CN 112794200 A relates to a container lifting appliance capable of being automatically adjusted in two directions, which includes a sling (1) hung on a hook, two parallel-arranged long lifting beams (2) connected to an end of the sling (1), two short lifting beams (3) arranged between corresponding ends of the two long lifting beams (2), movable lifting lugs (4) arranged at tops of two ends of the two long lifting beams (2), and a bidirectional regulating device connected to both the long lifting beams (2) and the short lifting beams (3). The long lifting beams (2) and the short lifting beams (3) are respectively provided with first bolt holes (13) for the bidirectional regulating device to regulate different setting locations. Compared with existing technologies, the present disclosure has the advantages of flexible lifting, wide applicability, automatic control, and high safety, etc. However, when the device is in use, a length of a lifting rope on the device is fixed, which makes it unable to regulate balance of the short lifting beams, so safety of the device is lower. Furthermore, lack of limit on the hook may cause the hook to fall from sliding rings during lifting processes. Therefore, the existing technologies need to be improved.

### SUMMARY

The present disclosure provides a sling mechanism for lifting a container, aimed at solving the problems of inability to regulate balance of short lifting beams, lower safety in using devices, and possibility of falling of hooks from sliding rings during lifting processes.

According to embodiments of the present disclosure, there is provided a sling mechanism for lifting a container, including a frame body. A supporting wheel is arranged on the frame body, and the supporting wheel comes into contact with a steel rope. A balance mechanism is arranged inside the frame body, a lifting frame is fixedly connected to the steel rope, and a sliding block is slidably connected to the lifting frame. A lifting drum is welded onto the sliding block, a lifting mechanism is arranged inside the lifting drum, and a regulating mechanism is arranged inside the lifting frame. The balance mechanism includes a motor fixedly installed on the frame body, where a rotation shaft of the motor is rotatably connected to the frame body. A gear is welded onto the rotation shaft, and the gear is meshed with a gear rack.

The regulating mechanism includes a reversible screw threaded rod, which is movably connected to the lifting frame. An electromotor is fixedly installed on the lifting frame, where an output end of the electromotor is rotatably connected to the lifting frame. A square rod is welded onto the output end, and the square rod is slidably connected to the reversible screw threaded rod. A cylinder is fixedly installed on the lifting frame, and a support plate is fixedly installed on a cylinder rod.

The lifting mechanism includes a hook movably connected to the lifting drum, where a limit plate is slidably connected to the hook, and a limit ring is fixedly sleeved on the hook. A spring is arranged on an outer side of the hook, and a compression ring is connected to the outer side of the hook through screw thread, where the compression ring comes into contact with the limit plate. A support shaft is connected to the hook through a bearing, and a stop lever is welded onto the support shaft, where the stop lever comes into contact with the limit plate.

In the sling mechanism for lifting the container of the present disclosure, a sliding chute is arranged on the lifting frame, and the lifting drum is slidably connected to the sliding chute. The lifting drum is guided by arranging the sliding chute.

In the sling mechanism for lifting the container of the present disclosure, the gear rack is slidably connected to the frame body, and a support rod is welded onto the gear rack.

In the sling mechanism for lifting the container of the present disclosure, a guide groove is arranged on the frame body, and a support rod is slidably connected into the guide groove. The support rod is guided by arranging the guide groove.

In the sling mechanism for lifting the container of the present disclosure, the cylinder rod of the cylinder is slidably connected to the lifting frame.

In the sling mechanism for lifting the container of the present disclosure, the support plate is slidably connected to the lifting frame, and the support plate is connected to the reversible screw threaded rod through the bearing. The reversible screw threaded rod is supported by arranging the support plate.

In the sling mechanism for lifting the container of the present disclosure, an irregularly-shaped hole is provided on the limit plate, and the hook is slidably connected into the irregularly-shaped hole.

In the sling mechanism for lifting the container of the present disclosure, one end of the spring comes into contact with the limit ring, and other end of the spring comes into contact with the limit plate. It is easy for the limit plate to return to its original state by arranging the spring.

The technical solutions provided by the embodiments of the present disclosure may include following beneficial effects.

In the present disclosure, there are provided structures such as the motor, the gear, the gear rack, the support rod, and the guide groove. The motor drives the gear to rotate, such that the gear drives the gear rack to move, allowing the steel rope to move, making it easy to regulate levelness of the lifting frame, and thus ensuring that two steel ropes are subjected to equal tension force. In this way, the lifting frame can be effectively prevented from swinging, thereby ensuring operation safety.

In the present disclosure, there are provided structures such as the reversible screw threaded rod, the electromotor, the square rod, the cylinder, the cylinder rod, and the support plate. The electromotor drives the square rod to rotate, thereby driving the reversible screw threaded rod to rotate, such that location change of the sliding block and location change of the lifting mechanism may be regulated according to a location of a lifting ring on the container, thus making the sling mechanism for lifting the container have wider applicability.

In the present disclosure, there are provided structures such as the hook, the limit plate, the limit ring, the spring, the compression ring, the irregularly-shaped hole, the support shaft, and the stop lever. The lifting ring on the container is hooked through the hook. The compression ring is rotated to carry out threaded movement with respect to the hook, the limit plate slides on the hook to seal the hook, and by rotating the stop lever to misalign the stop lever from the irregularly-shaped hole to limit the limit plate, the limit plate and the hook are limited. In this way, the hook is prevented from breaking away from the lifting rings on the container.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of an overall structure of the present disclosure;

FIG. 2 is a sectional view of a frame body in FIG. 1 of the present disclosure;

FIG. 3 is a right view of a gear in FIG. 2 of the present disclosure;

FIG. 4 is an enlarged view of a structure of Part A in FIG. 1 of the present disclosure;

FIG. 5 is a schematic diagram of a lifting mechanism in FIG. 1 of the present disclosure; and

FIG. 6 is a top view of an irregularly-shaped hole in FIG. 5 of the present disclosure.

### REFERENCE NUMERALS IN THE ACCOMPANYING DRAWINGS

frame body 1; supporting wheel 2; steel rope 3; balance mechanism 4; lifting frame 5; sliding block 6; regulating mechanism 7; lifting drum 8; lifting mechanism 9; sliding chute 10; motor 41; gear 42; gear rack 43; support rod 44; guide groove 45; reversible screw threaded rod 71; electromotor 72; square rod 73; cylinder 74; cylinder rod 75; support plate 76; hook 91; limit plate 92; limit ring 93; spring 94; compression ring 95; irregularly-shaped hole 96; support shaft 97; and stop lever 98.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

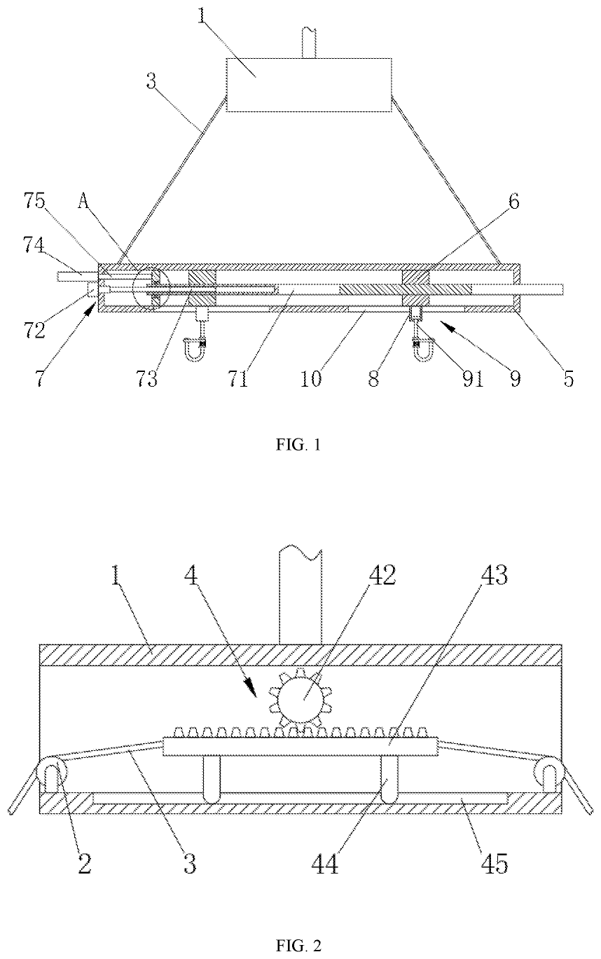

Referring to FIG. 1 and FIG. 2, a sling mechanism for lifting a container includes a frame body 1. A supporting wheel 2 is arranged on the frame body 1, and the supporting wheel 2 comes into contact with a steel rope 3. A balance mechanism 4 is arranged inside the frame body 1, a lifting frame 5 is fixedly connected to the steel rope 3, a sliding block 6 is slidably connected to the lifting frame 5, and a regulating mechanism 7 is arranged inside the lifting frame 5. A lifting drum 8 is welded onto the sliding block 6, and a lifting mechanism 9 is arranged inside the lifting drum 8.

Referring to FIG. 1, a sliding chute 10 is arranged on the lifting frame 5, and the lifting drum 8 is slidably connected to the sliding chute 10. The lifting drum 8 is guided by arranging the sliding chute 10.

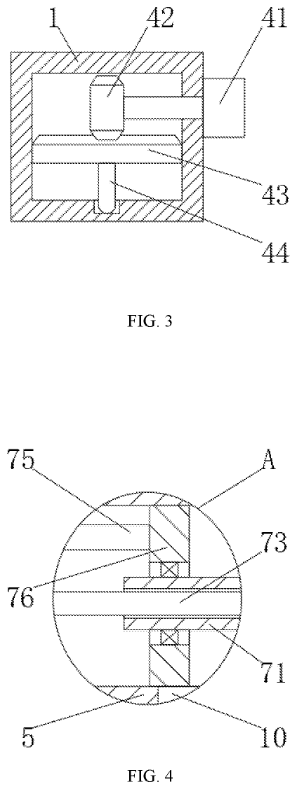

Referring to FIG. 2 and FIG. 3, the balance mechanism 4 includes a motor 41 fixedly installed on the frame body 1, where a rotation shaft of the motor 41 is rotatably connected to the frame body 1. A gear 42 is welded onto the rotation shaft, and the gear 42 is meshed with a gear rack 43. The gear rack 43 is slidably connected to the frame body 1, and a support rod 44 is welded onto the gear rack 43. Locations of two steel ropes 3 are regulated by arranging the balance mechanism 4.

Referring to FIG. 2, a guide groove 45 is arranged on the frame body 1, and a support rod 44 is slidably connected into the guide groove 45. The support rod 44 is guided by arranging the guide groove 45.

Referring to FIG. 1 and FIG. 4, the regulating mechanism 7 includes a reversible screw threaded rod 71, which is movably connected to the lifting frame 5. An electromotor 72 is fixedly installed on the lifting frame 5, where an output end of the electromotor 72 is rotatably connected to the lifting frame 5. A square rod 73 is welded onto the output end, and the square rod 73 is slidably connected to the reversible screw threaded rod 71. A cylinder 74 is fixedly installed on the lifting frame 5, where a cylinder rod 75 of the cylinder 74 is slidably connected to the lifting frame 5, and a support plate 76 is fixedly installed on the cylinder rod 75. The square rod 73 is driven by the electromotor 72 to rotate, and the square rod 73 drives the reversible screw threaded rod 71 to rotate, so the reversible screw threaded rod 71 rotates and carries out threaded movement with respect to the sliding block 6, such that location change of the sliding block 6 and location change of the lifting mechanism 9 may be regulated according to a location of a lifting ring on the container, thus making the sling mechanism for lifting the container have wider applicability.

Referring to FIG. 4, the support plate 76 is slidably connected to the lifting frame 5, and the support plate 76 is connected to the reversible screw threaded rod 71 through a bearing. The reversible screw threaded rod 71 is supported by arranging the support plate 76.

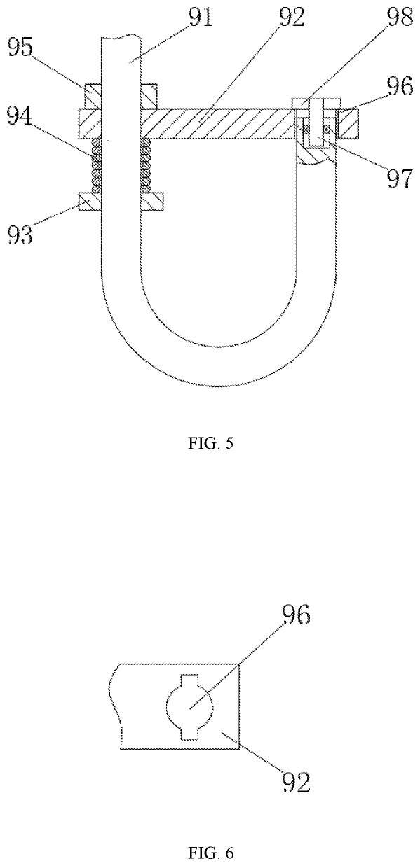

Referring to FIG. 1, FIG. 5, and FIG. 6, the lifting mechanism 9 includes a hook 91, which is movably connected to the lifting drum 8. A limit plate 92 is slidably connected to the hook 91, a limit ring 93 is fixedly sleeved on the hook 91, a spring 94 is arranged on an outer side of the hook 91, and a compression ring 95 is connected to the outer side of the hook 91 through screw thread, where the compression ring 95 comes into contact with the limit plate 92. An irregularly-shaped hole 96 is provided on the limit plate 92, and the hook 91 is slidably connected into the irregularly-shaped hole 96. A support shaft 97 is connected to the hook 91 through a bearing, and a stop lever 98 is welded onto the support shaft 97, where the stop lever 98 comes into contact with the limit plate 92. The hook 91 is hanged on the lifting ring, then the compression ring 95 is rotated to carry out threaded movement with respect to the hook 91, and then the compression ring 95 moves downwards, causing the limit plate 92 to slide on the hook 91, limiting the lifting ring inside the hook 91. Next, the stop lever 98 is rotated to misalign the stop lever 98 from the irregularly-shaped hole 96, such that the stop lever 98 limits the limit plate 92, and the limit plate 92 and the hook 91 are limited. In this way, the hook 91 is prevented from breaking away from the lifting ring on the container.

Referring to FIG. 5, one end of the spring 94 comes into contact with the limit ring 93, and other end of the spring 94 comes into contact with the limit plate 92. It is easy for the limit plate 92 to return to its original state by arranging the spring 94.

Specific implementation processes of the present disclosure are as follows. When in use, a device is moved above the container, and the electromotor 72 is started according to the location of the lifting ring on the container. After the electromotor 72 is started, it drives the square rod 73 to rotate, and the square rod 73 drives the reversible screw threaded rod 71 to rotate, such that the reversible screw threaded rod 71 rotates and carries out threaded movement with respect to the sliding block 6, thereby causing the location of the sliding block 6 to change, such that the lifting mechanism 9 corresponds to the location of the lifting ring on the container, By driving the square rod 73 to rotate through the electromotor 72, the reversible screw threaded rod 71 rotates, location change of the sliding block 6 and location change of the lifting mechanism 9 may be regulated according to the location of the lifting ring on the container, thus making the sling mechanism for lifting the container have wider applicability. Next, the hook 91 is hanged on the lifting ring, then the compression ring 95 is rotated to carry out threaded movement with respect to the hook 91, and then the compression ring 95 moves downwards, causing the limit plate 92 to slide on the hook 91, limiting the lifting ring inside the hook 91. Next, the stop lever 98 is rotated to misalign the stop lever 98 from the irregularly-shaped hole 96, such that the stop lever 98 limits the limit plate 92, and the limit plate 92 and the hook 91 are limited. In this way, the hook 91 is prevented from breaking away from the lifting ring on the container. During the lifting process, the motor 41 is started, and the motor 41 drives the gear 42 to rotate. Rotation of the gear 42 drives the gear rack 43 to move, causing the steel ropes 3 at two ends of the gear rack 43 to move, leading to change of levelness of the lifting frame 5, and thus ensuring that the two steel ropes 3 are subjected to equal tension force. In this way, the lifting frame 5 can be effectively prevented from swinging, thereby ensuring operation safety.

The preceding descriptions are merely specific embodiments of the present disclosure, but are not intended to limit the protection scope of the present disclosure. Any equivalent modifications or replacements easily conceivable to a person of skilled in the art within the technical scope disclosed in the present disclosure shall fall within the protection scope of the present disclosure. Therefore, the protection scope of the present disclosure shall be subjected to that of the claims.

What is claimed is:

1. A sling mechanism for lifting a container, comprising a frame body, wherein a supporting wheel is arranged on the frame body, the supporting wheel comes into contact with a steel rope, a balance mechanism is arranged inside the frame body, a lifting frame is fixedly connected to the steel rope, a sliding block is slidably connected to the lifting frame, a lifting drum is welded onto the sliding block, a lifting mechanism is arranged inside the lifting drum, a regulating mechanism is arranged inside the lifting frame, the balance mechanism comprises a motor fixedly installed on the frame body, a rotation shaft of the motor is rotatably connected to the frame body, a gear is welded onto the rotation shaft, and the gear is meshed with a gear rack;
the regulating mechanism comprises a reversible screw threaded rod, the reversible screw threaded rod is movably connected to the lifting frame, an electromotor is fixedly installed on the lifting frame, an output end of the electromotor is rotatably connected to the lifting frame, a square rod is welded onto the output end, the square rod is slidably connected to the reversible screw threaded rod, a cylinder is fixedly installed on the lifting frame, and a support plate is fixedly installed on a cylinder rod; and
the lifting mechanism comprises a hook movably connected to the lifting drum, a limit plate is slidably connected to the hook, a limit ring is fixedly sleeved on the hook, a spring is arranged on an outer side of the hook, a compression ring is connected to the outer side of the hook through screw thread, the compression ring comes into contact with the limit plate, a support shaft is connected to the hook through a bearing, a stop lever is welded onto the support shaft, the stop lever comes into contact with the limit plate.

2. The sling mechanism for lifting the container according to claim 1, wherein a sliding chute is arranged on the lifting frame, and the lifting drum is slidably connected to the sliding chute.

3. The sling mechanism for lifting the container according to claim 1, wherein the gear rack is slidably connected to the frame body, and a support rod is welded onto the gear rack.

4. The sling mechanism for lifting the container according to claim 1, wherein a guide groove is arranged on the frame body, and a support rod is slidably connected into the guide groove.

5. The sling mechanism for lifting the container according to claim 1, wherein the cylinder rod of the cylinder is slidably connected to the lifting frame.

6. The sling mechanism for lifting the container according to claim 1, wherein the support plate is slidably connected to the lifting frame, and the support plate is connected to the reversible screw threaded rod through the bearing.

7. The sling mechanism for lifting the container according to claim 1, wherein an irregularly-shaped hole is provided on the limit plate, and the hook is slidably connected into the irregularly-shaped hole.

8. The sling mechanism for lifting the container according to claim 1, wherein one end of the spring comes into contact with the limit ring, and other end of the spring comes into contact with the limit plate.
